(19) United States
(12) Patent Application Publication
(10) Pub. No.: US 2023/0291994 A1
(43) Pub. Date: Sep. 14, 2023

(54) PHOTOGRAPHING INFORMATION MANAGEMENT METHOD AND WORKER TERMINAL IN WHICH PROGRAM FOR EXECUTING PHOTOGRAPHING INFORMATION MANAGEMENT METHOD IS INSTALLED

(71) Applicant: Hanstyle Engineering Co., Ltd., Seoul (KR)

(72) Inventor: Da Woon JEONG, Seoul (KR)

(21) Appl. No.: 18/019,625

(22) PCT Filed: Jun. 15, 2021
(86) PCT No.: PCT/KR2021/007441

§ 371 Date: Feb. 3, 2023

(30) Foreign Application Priority Data
Aug. 6, 2020 (KR) 10-2020-0098558

(51) Int. Cl. H04N 23/62; G06T 11/60; G06Q 50/26

(52) U.S. Cl. CPC H04N 23/62; G06T 11/60; G06Q 50/265; G06T 2200/24

(57) ABSTRACT

Proposed are a photographing information management method and a worker terminal in which a program for executing the photographing information management method is installed. The method is implemented by a worker terminal through the processes of: outputting a drawing image of a photographing space, which is a space where a worker photographs, on a screen of the worker terminal; receiving an input of photographing point selection information, which is selection information of the worker on a point corresponding to the current location of the worker in the photographing space, on the drawing image of the photographing space output on the screen of the worker terminal; and storing the photographing point selection information and photographing direction information at the current location of the worker in association with a photographing image at the current location of the worker.

### TECHNICAL FIELD

The present invention relates to a photographing information management method and a worker terminal in which a program for executing the photographing information management method is installed, and more specifically, to a method for managing photographing information in such a way that a worker is able to more easily manage photographing information in a photographing space, as a photographing point and photographing direction information corresponding to each photographing image captured while the worker moves in the photographing space such as a building, etc. are additionally generated in a drawing image of the photographing space, and the worker is able to accurately record and manage the photographing direction information corresponding to each photographing image captured while moving in the photographing space, even including information on a vertical direction angle as well as a horizontal direction angle, and a worker terminal including a program installed therein to execute the photographing information management method.

### BACKGROUND ART

Commonly, a worker who visits a building to be inspected for safety in order to inspect and check safety due to a deterioration of the building, such as a crack initiation, takes photographs of an inspection target portion, such as a crack initiation portion of the wall, while moving inside the building with carrying a floor plan for each floor of the building.

As described above, the worker takes dozens of pictures while moving through each floor of the building, and then writes a building inspection report. In this process, the worker usually marks a photographing location and a photographing direction of the worker who took each picture separately on the floor plan for each floor.

Meanwhile, in the process of writing the building inspection report, in order to mark the photographing location and photographing direction on the floor plan for each floor, the worker moves inside the building in advance and photographs the inspection target portion, and at the same time, the photographing location and photographing direction for each photo should be recorded separately. However, due to various field situations at the inspection site, it is often difficult to perform accurate recording along with taking pictures.

In addition, there is a problem in that the quality of the building inspection report may be degraded in the case where on-site record information written by the worker, such as a photographing location and a photographing direction, is inaccurate.

### SUMMARY OF INVENTION

### Problems to be Solved by Invention

Accordingly, it is an object of the present invention to provide a method for managing photographing information in such a way that a worker is able to more easily manage photographing information in a photographing space, as a photographing point and photographing direction information corresponding to each photographing image captured while the worker moves in the photographing space such as a building, etc. are additionally generated in a drawing image of the photographing space, and the worker is able to accurately record and manage the photographing direction information corresponding to each photographing image captured while moving in the photographing space, even including information on a vertical direction angle as well as a horizontal direction angle, and a worker terminal including a program installed therein to execute the photographing information management method.

### Means for Solving Problems

To achieve the above objects, according to an aspect of the present invention, there is provided a method for managing photographing information, the method including: (a) outputting, by a worker terminal, a drawing image of a photographing space, which is a space where a worker performs photographing, on a screen of the worker terminal; (b) receiving, by the worker terminal, an input of photographing point selection information, which is selection information of the worker on a point corresponding to a current location of the worker in the photographing space, on the drawing image of the photographing space output on the screen of the worker terminal; and (c) storing, by the worker terminal, the photographing point selection information and photographing direction information at the current location of the worker in association with a photographing image at the current location of the worker.

Preferably, the method further includes receiving, by the worker terminal, an input of selection information of the worker on the drawing image of the photographing space.

In addition, the method may further include (d) overlapping, by the worker terminal, photographing information including the photographing point selection information and the photographing direction information at the current location of the worker with the drawing image of the photographing space selected by the worker.

In addition, after step (b) and before step (c), the method may further include detecting the photographing direction information at the current location of the worker.

Further, the photographing direction information may include horizontal direction angle information and vertical direction angle information.

Further, the horizontal direction angle information may be swipe direction information of the worker on the screen of the worker terminal on which the drawing image of the photographing space is output.

Further, the vertical direction angle information may be inclination angle information in a vertical direction of the worker terminal photographed at the current location of the worker.

Furthermore, the drawing image of the photographing space may be a plane image of the photographing space.

Meanwhile, according to another aspect of the present invention, there is provided a worker terminal comprising a program installed therein to execute the above method.

### Advantages Effects

According to the present invention, a worker may more easily manage photographing information in the photographing space, as the photographing point and photographing direction information corresponding to each photographing image captured while the worker moves in the photographing space such as a building, etc. are additionally generated in the drawing image of the photographing space.

In addition, according to the present invention, the worker may accurately record and manage the photographing direction information corresponding to each photographing image captured while moving in the photographing space, even including information on a vertical direction angle as well as a horizontal direction angle.

### BRIEF DESCRIPTION OF DRAWINGS

FIG. 1 is a flowchart illustrating an execution process of a photographing information management method according to an embodiment of the present invention.

FIGS. 2 to 6 are views illustrating screen states of a worker terminal in the execution of the photographing information management method according to an embodiment of the present invention.

### Mode for Carrying out Invention

Hereinafter, the present invention will be described with reference to the accompanying drawings in detail. Referring to the drawings, like reference characters designate like or corresponding parts throughout the several views. In the embodiments of the present invention, the publicly known functions and configurations that are judged to make the purport of the present invention unnecessarily obscure will not be described.

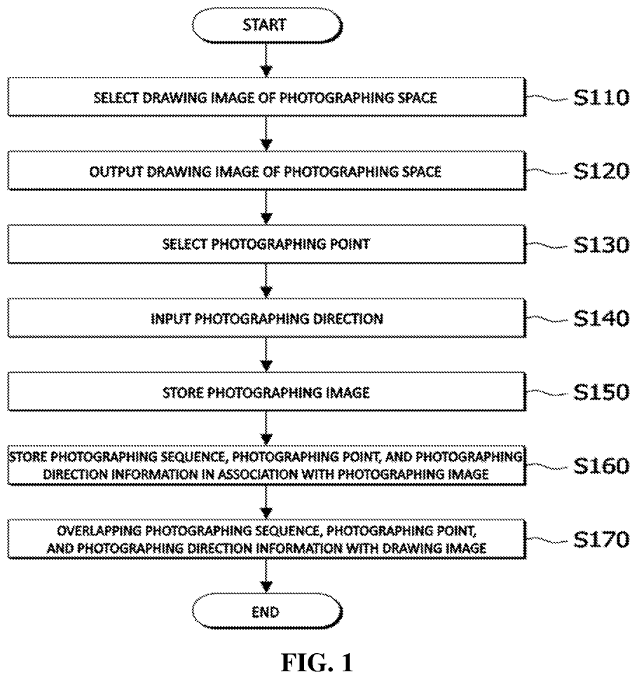

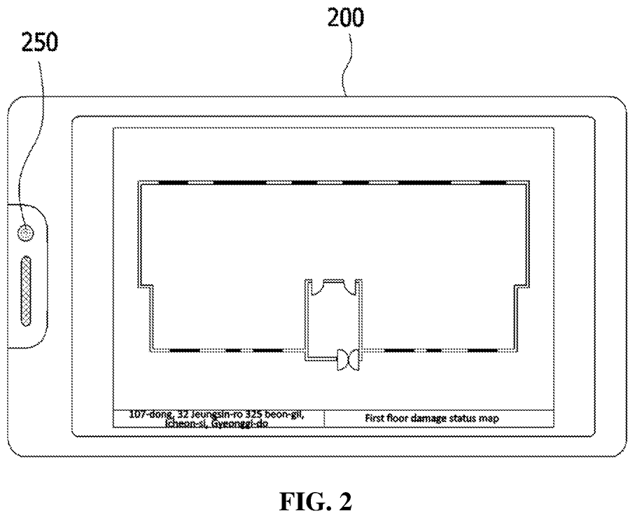

FIG. 1 is a flowchart illustrating an execution process of a photographing information management method according to an embodiment of the present invention, and FIGS. 2 to 6 are views illustrating screen states of a worker terminal 200 in the execution of the photographing information management method according to an embodiment of the present invention.

Meanwhile, the worker terminal 200 in the present invention may be a wireless communication terminal such as a smart phone possessed by a worker who performs building safety inspection, and an application program for executing the photographing information management method according to the present invention may be installed in the worker terminal 200.

Hereinafter, the execution process of the photographing information management method according to an embodiment of the present invention will be described with reference to FIGS. 1 to 6.

First, a worker who visits a building to be inspected for safety in order to check safety due to a deterioration of the building, such as crack initiation, selects a floor plan image file of a floor currently being inspected from among floor plan image files for each floor of the building, which are stored in the worker terminal 200 (S110).

Specifically, when a worker is performing a safety inspection on the first floor of the building, the worker selects a floor plan image file of the first floor from the floor plan image files for each floor stored in the worker terminal 200. Then, as shown in FIG. 2, a floor plan image of the first floor is output on the screen of the worker terminal 200 (S120).

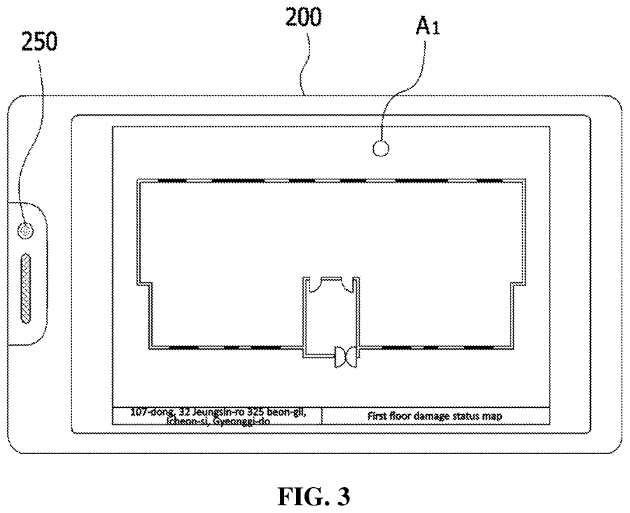

Thereafter, when the worker who performs a safety inspection while moving inside the floor checks an inspection target portion, such as a crack initiation portion of the wall, and decides to take a picture of the portion, the worker may select the current location where the worker is standing on the floor plan image of the floor displayed on the screen of the worker terminal 200 by a method such as a screen touch as shown in FIG. 3 (S130).

Meanwhile, the worker terminal 200 processes and records the current location selected by the worker on the floor plan image of the floor displayed on the screen of the worker terminal 200 as a photographing point A, which is a location of the worker who photographs the inspection target portion.

Accordingly, the first photographing point A1 of the worker is displayed on the screen of the worker terminal 200 as shown in FIG. 3. Thereafter, the worker confirms the location of the inspection target portion on the floor plan image of the floor displayed on the screen of the worker terminal 200, and then, in a state of touching the photographing point A1 on the screen of the worker terminal 200 with a finger, the worker may perform a swipe operation to input a photographing direction, which is a motion of moving the finger from the photographing point A1 to the direction of the inspection target portion (S140).

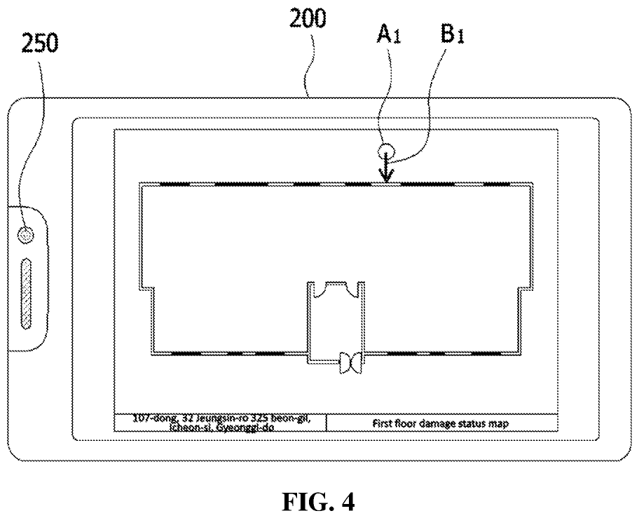

Thereby, the worker terminal 200 detects the swipe operation of the worker, and generates photographing direction B1 information at the photographing point A1 based on worker's swipe direction information, as shown in FIG. 4, such that the generated photographing direction B1 information may be displayed on the floor plan image of the floor as shown in FIG. 4.

Thereafter, as shown in FIG. 4, in a state of standing at the current location corresponding to the photographing point A1 displayed on the screen of the worker terminal 200, the worker may take a picture of the inspection target portion, such as a crack initiation portion of the wall, in the photographing direction B1 displayed on the screen of the worker terminal 200 using a camera module 250 provided in the worker terminal 200. The photographing image of the inspection target portion is stored in an internal memory provided in the worker terminal 200 (S150).

Meanwhile, in carrying out the present invention, it is preferable that the worker terminal 200 stores the photographing point A1 information selected by the worker in the above-described step S130 and the photographing direction B1 information input in the above-described step S140 in association with the photographing image stored in the above-described step S150 (S160).

In addition, in carrying out the present invention, it is preferable that the worker terminal 200 also stores photographing sequence information at the inspection site of the photographing image in association with the photographing image stored in the above-described step 5150.

Meanwhile, even if the worker does not directly input the photographing direction information into the worker terminal 200 through the swipe motion in the above-described step S140, it may be obtained in such a way that, in a state of standing at the current location corresponding to the photographing point A1 displayed on the screen of the worker terminal 200 as shown in FIG. 3, when selecting a photographing button by the worker in a state where the camera module 250 provided in the worker terminal 200 faces the inspection target portion, the photographing direction B1 information is generated by the worker terminal 200 at the time of taking a photograph based on azimuth angle information measured by a geomagnetic sensor provided in the worker terminal 200.

In this case, it is preferable that each floor plan image stored in the worker terminal 200 includes the azimuth angle information of each floor plan so that the photographing direction B1 information at the photographing point A1 can be appropriately displayed on the floor plan image of the floor by the worker terminal 200 as shown in FIG. 4.

In addition, in carrying out the present invention, the photographing direction information in the above-described step S140 may include vertical direction angle information as well as horizontal direction angle information as described above.

Specifically, in carrying out the present invention, in the above-described step S140, the worker may additionally input the vertical direction angle information into the worker terminal 200, which is an inclination angle in the vertical direction from the worker terminal 200 to the inspection target portion to be photographed through the camera module 250 provided in the worker terminal 200.

Meanwhile, in carrying out the present invention, the worker does not directly input the vertical direction angle information into the worker terminal 200 in the above-described step S140, instead it may be obtained in such a way that, at the current location corresponding to the photographing point A1 displayed on the screen of the worker terminal 200 as shown in FIG. 3, when selecting the photographing button by the worker in a state where the camera module 250 provided in the worker terminal 200 faces the inspection target portion, the vertical direction angle information at the time of taking a photograph is generated by the worker terminal 200 based on inclination angle information in the vertical direction measured by a gyro sensor provided in the worker terminal 200.

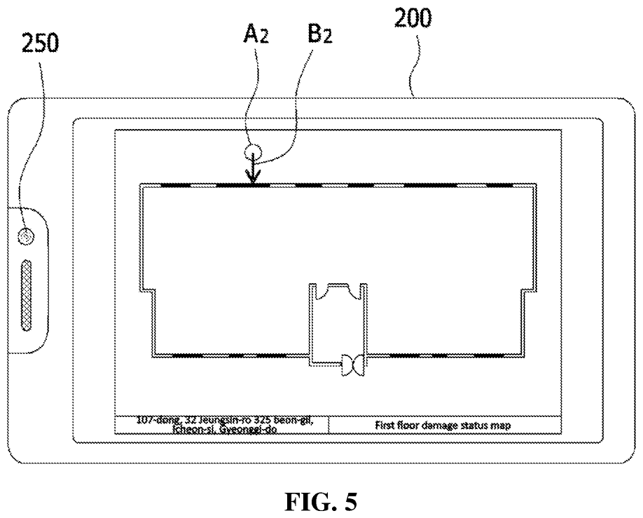

In this way, after the photographing at the first photographing point A1 is completed, when the worker decides to photograph a second inspection target portion while moving inside the floor, second photographing point A2 information and second photographing direction B2 information may be input in the same method as the above-described steps S130 and S140 as shown in FIG. 5.

Thereafter, as the photographing is completed at the second photographing point A2, the worker terminal 200 repeatedly performs the above-described steps S150 and S160, and the worker performs additional photographing on the floor in the same method as described above, then the worker performs photographing on the next floor (e.g., second floor) in the same manner as described above.

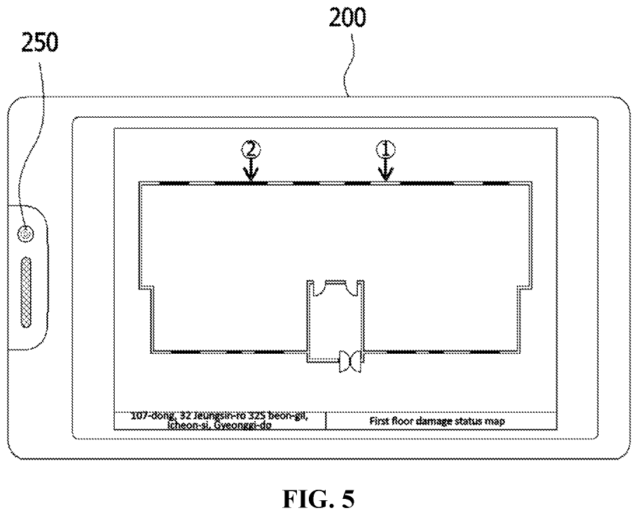

Meanwhile, it is preferable that the worker terminal 200 overlaps the photographing point information and the photographing direction information stored in association with each photographing image which is taken and stored in the above-described continuous photographing process with a plane image selected by the worker in step 5110, thereby additionally generating a plane image for making a building inspection report as shown in FIG. 6 (S170).

In addition, in carrying out the present invention, as shown in FIG. 6, the worker terminal 200 may also overlap the photographing sequence information of each photographing image at the inspection site with the plane image selected by the worker in the above-described step S110, thereby additionally generating the plane image for making the building inspection report.

Accordingly, in making the building inspection report later, the worker may confirm the generated plane image for each floor for making the inspection report through the screen of the worker terminal 200 as shown in FIG. 6.

Meanwhile, in carrying out the present invention, when the worker selects the photographing sequence information, the photographing point information, or the photographing direction information overlapped with the plane image for making the inspection report on the screen of the worker terminal 200 by a touch method, the worker terminal 200 may output the photographing image stored in association with the information selected by the worker on the screen of the worker terminal 200, so as to more smoothly support the task of making the inspection report prepared by the worker.

In addition, by executing the steps S130 and S140 as described above, it is possible to take a picture of the inspection target portion in a state where the photographing point information and the photographing direction information are input to the worker terminal 200. However, in carrying out the present invention, by first taking a picture of the inspection target portion and then executing the above-described steps S130 and S140, the photographing point information and the photographing direction information may be input into the worker terminal 200.

Terms used in the present invention are used only to describe specific embodiments, and are not intended to limit the present invention. Singular expressions used herein include plural expressions unless they have definitely opposite meanings in the context. In the present application, it should be understood that term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance.

While the present invention has been described with reference to the preferred embodiments and modified examples, the present invention is not limited to the above-described specific embodiments and the modified examples, and it will be understood by those skilled in the art that various modifications and variations may be made therein without departing from the scope of the present invention as defined by the appended claims, as well as these modifications and variations should not be understood separately from the technical idea and prospect of the present invention.

### INDUSTRIAL APPLICABILITY

The present invention may be applied to the industrial fields related to safety inspection of buildings, such that industrial applicability thereof may be recognized.

1. A method for managing photographing information, the method comprising:
(a) outputting, by a worker terminal, a drawing image of a photographing space, which is a space where a worker performs photographing, on a screen of the worker terminal;
(b) receiving, by the worker terminal, an input of photographing point selection information, which is selection information of the worker on a point corresponding to a current location of the worker in the photographing space, on the drawing image of the photographing space output on the screen of the worker terminal; and
(c) storing, by the worker terminal, the photographing point selection information and photographing direction information at the current location of the worker in association with a photographing image at the current location of the worker.

2. The method according to claim 1,
before step (a),
further comprising receiving, by the worker terminal, an input of selection information of the worker on the drawing image of the photographing space.

3. The method according to claim 1,
further comprising (d) overlapping, by the worker terminal, photographing information including the photographing point selection information and the photographing direction information at the current location of the worker with the drawing image of the photographing space selected by the worker.

4. A worker terminal comprising a program installed therein to execute the method according to claim 1.

5. A worker terminal comprising a program installed therein to execute the method according to claim 2.

6. A worker terminal comprising a program installed therein to execute the method according to claim 3.
